(19) United States
(12) Patent Application Publication
(10) Pub. No.: US 2004/0207719 A1
(43) Pub. Date: Oct. 21, 2004

(54) Method and apparatus for exploiting video streaming services of mobile terminals via proximity connections

(76) Inventors: Timo P. Tervo, Oulu (FI); Marko Leukkunen, Oulu (FI)

Correspondence Address: CRAWFORD MAUNU PLLC, Suite 390, 1270 Northland Drive, St. Paul, MN, 55120, US

(21) Appl. No.: 10/414,453

(22) Filed: Apr. 15, 2003

(51) Int. Cl. H04N 7/14

(52) U.S. Cl. 348/14.02; 348/14.08

(57) ABSTRACT

A method and apparatus allows proximity connections to an image enabled mobile terminal to exploit image capabilities of the mobile terminal. Mobile terminals (504 and 512) interact with Personal Computers (PC) (506 and 510) via Bluetooth connections (516 and 522) to transfer audio/video data as required to support specified activities. Video conferencing scenario 500 is enabled by exploiting imaging capabilities of the mobile terminals in lieu of a PC mounted camera. Other applications involve security, licensing, video enhancement, and gaming features that may be implemented with the present invention.

### FIELD OF THE INVENTION

This invention relates in general to multi-modal usage of a mobile terminal, and more particularly, to providing alternative usages of mobile terminals for video conferencing and video enhancement operations.

### BACKGROUND OF THE INVENTION

Mobile terminals of the present day have evolved according to the needs and desires of the mobile terminal market. In the early phases of the market, mobile terminals were significantly costlier, larger, heavier, and less energy efficient than they are today. Furthermore, the early mobile terminals provided a significantly smaller set of value added features and performance. The early phases of the mobile terminal market was driven by business customers, where the key competitive mobile terminal parameters consisted of size and talk time, which was largely a function of battery charge duration.

As the business market began to grow, the mobile terminals began to segment themselves according to price differential and performance. The higher end mobile terminals, for example, were targeted for business customers relying on enhanced performance where price was a secondary issue. Alternatively, middle and low end mobile terminals were offered having a reduced function set, an affordable cost, and were targeted for private, cost-sensitive customers.

As the private market began to grow, lifestyle of the private consumer began to provide an input to the segmentation of the mobile terminal portfolio. As such, a much wider range of products with a strong differentiation in design and styling began to emerge to match the highly diverse consumer segment needs. Generally speaking, the thrust of the mobile terminal market was to bring mobility to voice communications.

The evolution towards Third Generation (3G) mobile communications and digital convergence allows the opportunity to bring mobility to functions other than voice. As endless opportunities present themselves, it is important to identify the most attractive new functionalities and create mobile terminals which are optimized for use of those functionalities. It remains equally important to concurrently provide a full set of mobile applications to ensure the usability of the mobile terminal within the communications network to which the consumer has already grown accustomed.

For example, terminals optimized for imaging must excel in the capturing, handling, sending, and storing of images. The image enabled mobile terminals must, therefore, provide a large color display for imaging content presentation and an internal camera for imaging content capture. The image enabled mobile terminal must also support the Multimedia Messaging Service (MMS), Short Message Service (SMS), Personal Information Management (PIM), games, voice, etc. in order to become the mobile terminal companion of choice for the consumer.

Image enabled terminals that provide mobility to the user have created a strong emotional attachment between the users because the mobile imaging terminals provide a mechanism whereby users are able to share life's experiences through rich communication. Person to person multimedia communications, with self-created content, represents a natural progression of today's communication paradigm and comes one step closer to virtual presence.

As the progression to virtual presence continues, the number of value added applications provided by the mobile imaging terminals grows. Challenges presented by the implementation of those value added applications, however, also continues to grow. For example, although the image size and quality presented by the mobile imaging terminal is enhanced, the mobile imaging terminal can not present the same amount or variety of information as can be provided to a user of a Personal Computer (PC). As such, the screen size of the mobile terminal creates a challenge to content providers because the displays have less graphical area available to them for display of their content. By increasing the resolution of the display, more information may be projected onto the display, but the readability of the content decreases. Usage of page sizes that are larger than the display size of the mobile terminal is also an option, but navigation around the oversized page requires increased scrolling interaction by the user.

Other applications may take the mobile terminal out of its traditional role by exploiting the data processing capabilities of the mobile terminal to enhance the performance of terminals in proximity to the mobile terminal. Video conferencing, for example, is an activity that has typically been served through fixed media devices. The fixed media devices including audio and video signal processing terminals along with corresponding PC based conference software to enable a virtual meeting between parties that are physically separated. Each party to the video conference, however, must provide his own set of conference supporting media, such as a PC mounted camera or Integrated Services Digital Network (ISDN) video conferencing equipment, in order to project his own personal image and any other audio/video content required to support the video conference. In some cases, however, the particular PC in use by one of the parties to the video conference is not equipped with a camera or Web Cam and is thus deprived of the opportunity to provide video input to the video conference.

Accordingly, there is a need in the communications industry for a method and apparatus that exploits the capabilities of mobile terminals to increase the number of value added services that may be facilitated through their use. In particular, the capabilities of image enabled mobile terminals needs to be exploited, in order to couple those capabilities to existing network infrastructure via proximity connections to enable the value added services.

Additionally, the coupling mechanism used to exploit the capabilities of the mobile terminals needs to be adapted to enhance the services provided to a user of the mobile terminal. In such an adaptation, the user's total experience in using the particular application may be enhanced through the use of other terminals/applications in proximity to the mobile terminal.

### SUMMARY OF THE INVENTION

To overcome limitations in the prior art, and to overcome other limitations that will become apparent upon reading and understanding the present specification, the present invention discloses a system and method for providing exploitation of the capabilities of mobile terminals to support and enhance their video functions.

In accordance with one embodiment of the invention, a method is provided of exploiting video facilities of a mobile terminal. The method comprises generating video content using the mobile terminal, establishing a proximity connection between the mobile terminal and a video processing platform, and transferring the video content from the mobile terminal to the video processing platform using the proximity connection.

In accordance with another embodiment of the invention, an image processing system is provided. The image processing system comprises an image enabled mobile terminal arranged to generate content and an image processing platform arranged to receive the content. The image enabled mobile terminal is coupled to the image processing platform via a proximity connection to transfer the content.

In accordance with another embodiment of the invention, a mobile terminal wirelessly coupled to a network which includes a network element capable of processing content from the mobile terminal in provided. The mobile terminal comprises a memory capable of storing at least one of a protocol module and an imaging module, an image component configured by the imaging module to generate digital images, a processor coupled to the memory and configured by the protocol module to enable digital image exchange with the network element, and a transceiver configured to facilitate the digital image exchange with the network element.

In accordance with another embodiment of the invention, a computer-readable medium having instructions stored thereon which are executable by a mobile terminal for exchanging video content with a video processing platform is provided. The instructions perform steps comprising generating digital images using imaging equipment internal to the mobile terminal, establishing a proximity connection with the video processing platform, and transmitting the digital images to the video processing platform with the established proximity connection.

In accordance with another embodiment of the invention, a digital image processor proximately coupled to an image enabled mobile terminal is provided. The digital image processor comprises various arrangements for establishing the proximate connection to the image enabled mobile terminal, receiving video content from the image enabled mobile terminal via the proximate connection, and utilizing the received video content.

In accordance with another embodiment of the invention, a computer-readable medium having instructions stored thereon which are executable by a video processing platform is provided. The instructions perform steps comprising establishing a proximate connection with an image capable mobile terminal, receiving images from the image capable mobile terminal via the proximate connection, and utilizing the received images.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system and method in accordance with the invention.

### BRIEF DESCRIPTION OF THE DRAWINGS

The invention is described in connection with the embodiments illustrated in the following diagrams.

FIG. 1 illustrates a block diagram according to the principles of the present invention;

FIG. 2 illustrates a block diagram of key components of content capture;

FIG. 3 illustrates a Bluetooth stack hierarchy;

FIG. 4 illustrates a generic communication architecture according to the present invention;

FIG. 5 illustrates an exemplary video conferencing scenario enabled by the principles of the present invention;

FIG. 6 illustrates a flow diagram of an exemplary setup required for a proximity connection transfer according to the present invention;

FIG. 7 illustrates a representative mobile computing arrangement suitable for providing imaging data in accordance with the present invention; and

FIG. 8 is a representative computing system capable of carrying out image processing functions according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a method and apparatus to facilitate a proximity connection between a mobile terminal and a PC, or other image processing platform, in order to exploit the functional capabilities of the mobile terminal. Various applications and embodiments in accordance with the present invention are presented that extract outbound video data, for example, from an image enabled mobile terminal to facilitate video conferencing. In such an instance, a proximity connection between the mobile terminal and an auxiliary device, such as a PC or other equivalent terminal, is established to enable the extraction of the video content from the mobile terminal. The video content may be either self-generated by the mobile terminal itself, e.g., generated by a camera built into the mobile terminal, or may be generated by an external device, e.g., pre-recorded video content from a Digital Versatile Disk (DVD) or equivalent storage device, and routed through the mobile terminal for proximity transport to the auxiliary device.

The present invention also supports the enhancement of in-bound video data intended to be rendered on the mobile terminal's display. The video data may be enhanced by, for example, allowing any video content received by the mobile terminal to be displayed by an auxiliary video display device, thus bypassing the normal video display of the mobile terminal. In such an instance, the user of any terminal, e.g., land, mobile or otherwise, that incorporates features in accordance with the present invention may enhance his viewing pleasure by facilitating an enhanced rendition of the received video content, e.g., larger size, greater resolution, increased color palette, through the use of an auxiliary video display device.

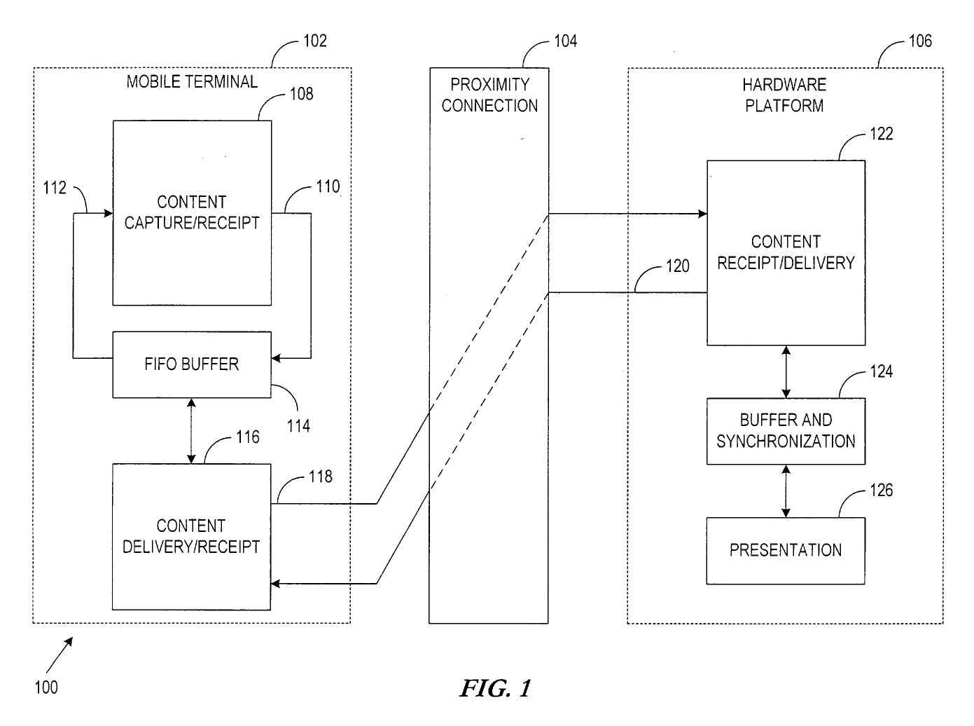

FIG. 1 illustrates a high level block diagram illustrating the principles of the present invention. In general, mobile terminal 102 is arranged to transfer data to hardware platform 106 via path 118 and is arranged to receive acknowledgment of the received data via path 120. The nature of the data transfer may be of any type and rate that is supported by proximity connection 104, mobile terminal 102 and hardware platform 106. One of ordinary skill in the art will recognize that any data type may be supported by such an arrangement. The data, for example, may be synchronization data that is transferred by mobile terminal 102 to hardware platform 106, e.g. a Personal Computer (PC), in order to obtain a common data store between the two devices via a data synchronization standard such as SyncML. The synchronization data may support such activities as calendar synchronization, contact synchronization, to-do lists, etc. as required between the mobile terminal 102 and PC 106 to provide such a common data store. SyncML may also support data types such as images, files and database objects. It should also be noted, that data transfer from hardware platform 106 may also be received by mobile terminal 102. In such an instance, data flow path between hardware platform 106 and mobile terminal 102 is facilitated through path 120, while acknowledgment of the data receipt is provided by path 118.

For purposes of exemplifying the present invention, block diagram 100 is discussed in terms of a content transport mechanism between mobile terminal 102 and hardware platform 106, whereby proximity connection 104 is utilized as the communication conduit between the two devices. Proximity connection 104 may represent a wired and/or a wireless connection. Wired implementations of proximity connection 104 may include single ended data transmission formats such as those specified by the RS232 or RS432 standards, or may include differential data transmission formats such as those specified by the RS422 or RS485 standards. Other wired implementations for higher bandwidth considerations may use the Universal Serial Bus (USB), or FireWire, specifications for example. Wireless implementations of proximity connection 104 may include Wireless Local Area Network (WLAN), Bluetooth, Infrared, etc. as required by the particular application.

In operation, mobile terminal 102 may be an image enabled device having content capture/receipt capability 108. Content capture/receipt 108 may provide both audio and video data, whereby the images may be presented in still and/or video mode. In still mode, only a single image is transferred via path 110 to First-In First-Out (FIFO) buffer 114, where acknowledgement of the content receipt is generated via path 112. In video mode, multiple images arranged in back to back frame sequence are transferred to FIFO buffer 114 at a rate of, for example, 10-20 Frames per Second (FPS). FIFO buffer 114 buffers the content blocks, while content delivery/receipt 116 prepares for their subsequent transfer to hardware platform 106 via path 118 through proximity connection 104. Path 120 is used by content receipt/delivery 122 to acknowledge receipt of the images from content delivery 116 via proximity connection 104. Buffer and synchronization block 124 is used to provide the proper frame alignment and playback speed as required by presentation 126. Presentation 126 represents any Application Programming Interface (API) that is executing on hardware platform 106 including image processing software in support of video conferencing, photo identification card generation, photo identification security, etc.

The images transferred via proximity path 104 may be formatted in any one of a number of video formats to include Moving Pictures Expert Group (MPEG), MPEG version 4 (MPEG-4), Joint Photographic Experts Group (JPEG), to name only a few. In addition, vector graphic files may be transmitted where creation of digital images is facilitated through a sequence of commands or mathematical statements that place lines and shapes in a given two-dimensional or three-dimensional space. In vector graphics, the file that results from a graphic artist's work is created and saved as a sequence of vector statements. For example, instead of containing a bit in the file for each bit of a line drawing, a vector graphic file describes a series of points to be connected. Alternatively, the vector graphics file may be converted to a raster graphics image by content delivery/receipt 116 prior to transmission, so as to increase portability between systems. Exemplary vector graphic files may be created, for example, by using Adobe Illustrator and CorelDraw. Additionally, animation images are also usually created as vector files, using content creation products such as Shockwave's Flash that allows creation of 2-D and 3-D animations that may be sent to content receipt/delivery 122 as a vector file and then rasterized “on the fly” as they arrive by presentation 126.

Content capture/receipt 108 may produce a video sequence consisting of a series of still images for ultimate buffering into FIFO buffer 114. Content capture/receipt 108 may also provide audio capture capability, depending upon the capabilities/feature selection represented by mobile terminal 102. Additionally, audio and video data streams may be received from FIFO buffer 114 by content capture/receipt 108 for subsequent display by mobile terminal 102. The audio and video data streams may have previously been received from an external device (not shown), from hardware platform 106, or from an attachment contained within an MMS message, for example.

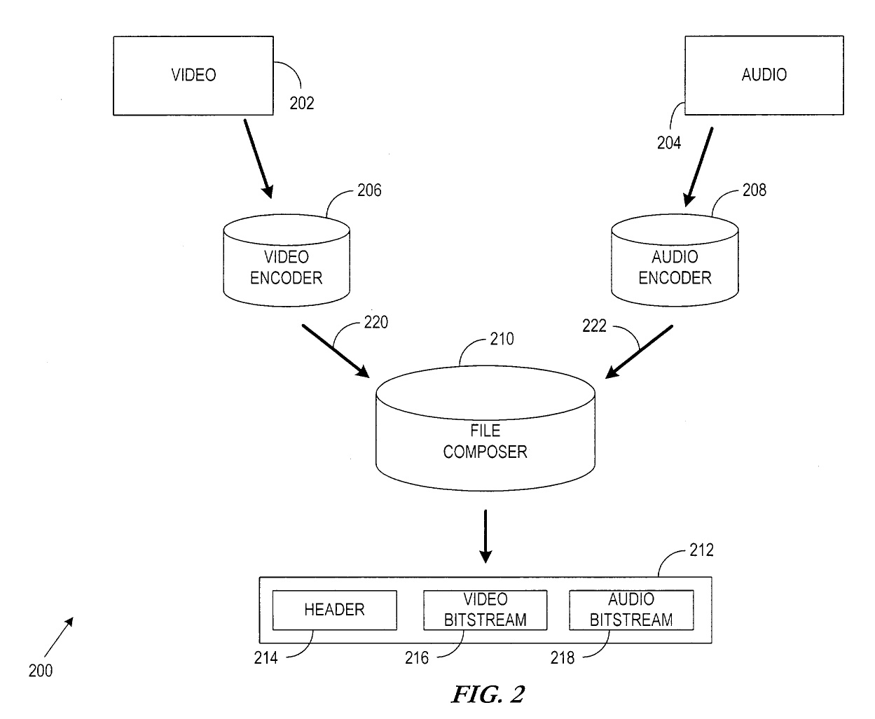

FIG. 2 illustrates an exemplary block diagram of some of the key elements provided by content capture 108 as they relate to the principles of the present invention. Video block 202 may provide a single image or a series of images to video encoder 206. In the case that a series of images are provided, video encoder 206 implements video compression methods that exploit redundant and perceptually irrelevant parts of the video series. The redundancy can be categorized into spatial, temporal, and spectral components; where spatial redundancy relates to correlation between neighboring pixels; temporal redundancy relates to objects likely to appear in present frames that were there in past frames; and spectral redundancy addresses the correlation between the different color components of the same image. Video encoder 206 achieves video compression by generating motion compensation data, which describes the motion between the current and previous image. Video encoder 206 may seek to establish a constant bit rate for data stream 220, in which case video encoder 206 controls the frame rate as well as the quality of images.

Video encoder 206 may implement a video COder/DECoder (CODEC) algorithm defined by ITU-T H.263, which is an established CODEC scheme used in various multimedia services. H.263 provides a wide toolbox of various encoding tools and coding complexities for different purposes. A definition of the tools to be used and the allowed complexity of the mode are defined in CODEC profiles and levels, such as Profile 0, Level 10, also known as the H.263 baseline, has been defined as a mandatory video CODEC. Video encoder 206 may also support decoding of video bit-stream content conforming to MPEG-4 Visual Simple Profile, Level 0. Other proprietary video coding formats, such as RealVideo 7 and RealVideo 8, may be used that are recognized by the RealOne Player utility.

Audio block 204 represents an audio generation function of mobile terminal 102, such as a microphone, that provides a series of amplitude waveforms over a period of time to audio encoder 208. The amplitude waveforms are digitized prior to delivery to audio encoder, where the sampling rate imposed is dependent upon the nature of the sound to be digitized. Music, for example, requires a 44.1 Kilohertz (KHz) sampling rate in order to provide high quality. Speech, on the other hand, may be adequately sampled at an 8 KHz sampling rate.

Audio encoder 208 compresses the digitized data received from audio block 204 using a number of different compression algorithms. One simple coding method uses an adaptive step size to quantize audio samples. Such a technique is used by the Interactive Multimedia Association (IMA) Adaptive Pulse Code Modulation (ADPCM) audio coding standard that reserves 4 bits per sample. Consequently, if the sampling rate is set to 8 KHz, IMA ADPCM coded audio requires a 32 KHz bit stream to be transferred by path 222. Other simple speech coding methods include the A-Law and μ-Law coding algorithms, which uses a logarithmic quantization step size and reserves 8 bits per sample. One of the most advanced speech coding standards used by audio encoder 208, is the Adaptive Multi-Rate (AMR) speech codec, which includes eight speech coding modes, whose bit rates range from 4.75 to 12.2 kilobits per second (kbps). AMR implements a limited audio bandwidth of 3.5 KHz and has been proven to work satisfactorily with news and sports coverage as well as light, popular music.

File composer 210 receives video encoded data stream 220 and audio encoded data stream 222 and composes data file 212 from the respective data streams. It should be noted that the audio portion of content capture 200 is optional, depending upon the capabilities/feature selection currently implemented by mobile terminal 102. In the event that a single image is to be transmitted via MMS, for example, the audio portion of the content captured by content capture 108 of FIG. 1 may be omitted by a feature that is selected locally within mobile terminal 102.

File composer 210 groups video data stream 220 and optionally, audio data stream 222, into file format 212. Once formatted, file format 212 may be processed locally within mobile terminal 102, streamed over transport channel 118 via proximity connection 104 to hardware platform 106, or dispatched in any number of other formats and protocols as permitted by the capabilities of mobile terminal 102. Some exemplary file formats provided by file composer 210 may include Microsoft Audio-Video Interleaved (AVI), Apple Quicktime file format (.mov), MPEG-1 file format (.mpg), 3GPP file format (0.3gp), and MP4 file format (.mp4), etc. Header 214 provides specific information about the file format such as video coding type, audio coding type, length of file, file identifier, etc. Video bit stream 216 and audio bit stream 218 contain the respective video bit stream 220 and audio bit stream 222 as received and formatted by file composer 210.

Proximity connection 104 of FIG. 1 provides the conduit for data transfer between mobile terminal 102 and hardware platform 106. For reasons of exemplification, proximity connection 104 is described in terms of the Bluetooth standard for localized data transfer. Bluetooth technology is an industry standard for short-range wireless voice and data communications, allowing a single air interface to support local communications for distances of up to 10-20 meters.

Mobile terminal 102 of FIG. 1 may be implemented using a Series 60 Platform, for example, that is built upon the Symbian Operating System (OS) General Technology (GT). Symbian GT provides a fully object-oriented design, preemptive multi-tasking, and full support for client-server architecture. Symbian GT also provides the common core for API and technology, which is shared between all Symbian reference designs. Some of the major components supported by Symbian GT include a multimedia server for audio recording, playback, and image-related functionality, as well as a Personal Area Network (PAN) communication stack including infrared, Bluetooth and serial communications support. As such, Symbian GT allows the use of Bluetooth technology to allow proximity, wireless operations to utilize local service accessories. The number and type of local service accessories provided by the Bluetooth connection are virtually unlimited and they include for example; bar code readers, digital pens, health monitoring devices, Global Positioning System (GPS) receivers, enhanced video feeds, and video conferencing facilitation.

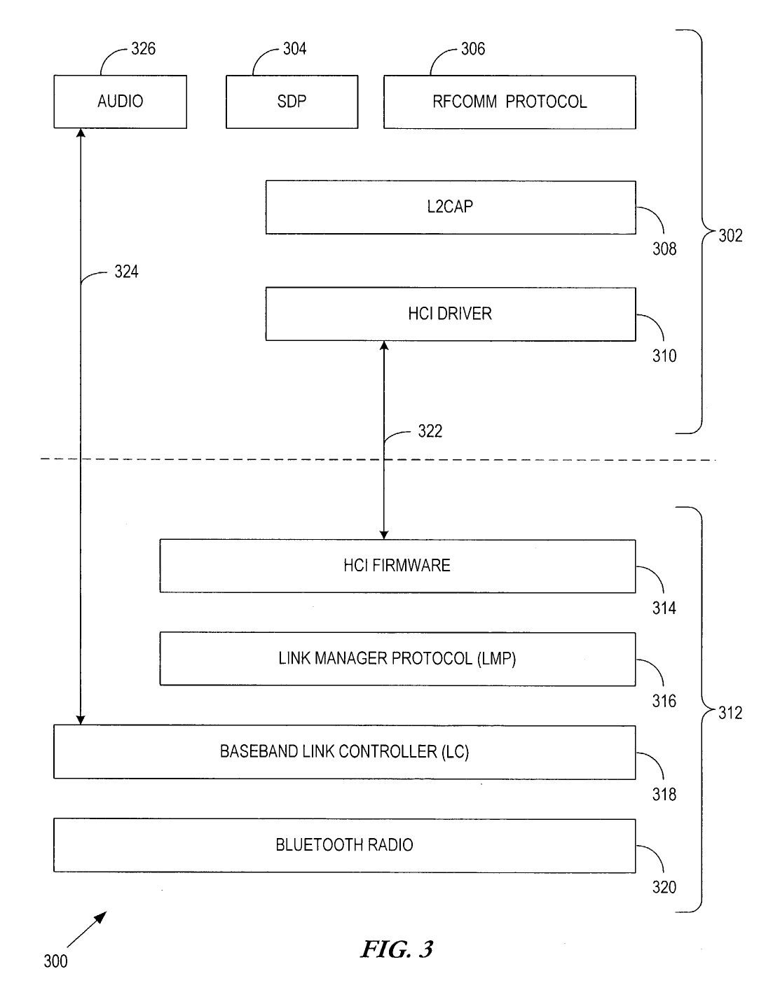

Like many other communication technologies, Bluetooth is composed of a hierarchy of components that is exemplified in Bluetooth stack hierarchy 300 shown in FIG. 3. The Bluetooth communication stack may be broken into two main components. The first component, Bluetooth Host Controller (BTHC) 312, provides the lower level of the stack. BTHC 312 is generally implemented in hardware and allows the upper level stack, Bluetooth Host (BTH) 302, to send or receive data over a Bluetooth link and to configure the Bluetooth link. Configuration and data transfer between BTHC 312 and BTH 302 takes place via path 322, which connects Host Controller Interface (HCI) driver 310 with HCI firmware module 312.

Bluetooth operates in the 2.4 gigahertz (GHz) Industrial, Scientific, and Medical (ISM) band. It uses a fast frequency hopping scheme with 79 frequency channels, each being 1 MHz wide. Bluetooth Radio (BTR) 320 is designed to provide a low-cost, 64 kbps, full-duplex connection that exhibits low power consumption. Power consumption on the order of 10-30 milliamps (mA) is typical, where even lower power consumption exists during idle periods.

Baseband link controller (LC) 318 defines different packet types to be used for both synchronous and asynchronous transmission. Packet types supporting different error handling techniques, e.g., error correction/detection, and encryption, are also defined within LC 318. LC 318 also mitigates any Direct Current (DC) offsets provided by BTR 320 due to special payload characteristics. Link Manager Protocol (LMP) 316 is responsible for controlling the connections of a device, like connection establishment, link detachment, security management, e.g., authentication, encryption, and power management of various low power modes.

BTH 302 illustrates the upper level of a Bluetooth stack and is comprised primarily of software applications 304-310, and 326. HCl driver 310 packages the high level components that communicate with the lower level hardware components found in BTHC 312. Logical Link Control and Adaptation Protocol (L2CAP) 308 allows finer grain control of the radio link. For example, L2CAP 308 controls how multiple users of the link are multiplexed together, controls packet segmentation and reassembly, and conveys quality of service information.

Service Discovery Protocol (SDP) 304 and Radio Frequency Communication (RFCOMM) protocol 306 represent middleware protocols of the Bluetooth stack. RFCOMM protocol 306 allows applications communicating with Bluetooth stack 300 to treat a Bluetooth enabled device as if it were a serial communications device, in order to support legacy protocols. RFCOMM protocol 306 defines a virtual set of serial port applications, which allows RFCOMM protocol 306 to replace cable enabled communications. The definition of RFCOMM protocol 306 incorporates major parts of the European Telecommunication Standards Institute (ETSI) TS 07.10 standard, which defines multiplexed serial communication over a single serial link. Service Discovery Protocol (SDP) 304 is used to locate and describe services provided by or available through another Bluetooth device. SDP 304 plays an important role in managing Bluetooth devices in a Bluetooth environment by allowing discovery and service description of services offered within the environment. Audio block 326 represents another middleware component of stack 300 that allows Bluetooth to offer audio and telephony support. The audio portion of Bluetooth data may be transferred directly from LC 318 to audio block 326 via path 324, thereby bypassing the LMP 316, HCI 310 and 314, and the L2CAP 308 layers.

The Bluetooth communication stack of FIG. 3 represents the lower communication layers that support any number of higher level application embodiments according to the present invention. Returning to FIG. 1, for example, mobile terminal 102 and hardware platform 106 may each employ Bluetooth communication stack 300, in order to facilitate image and voice data transfer, whereby presentation software and camera APIs are implemented as necessary for image generation and display.

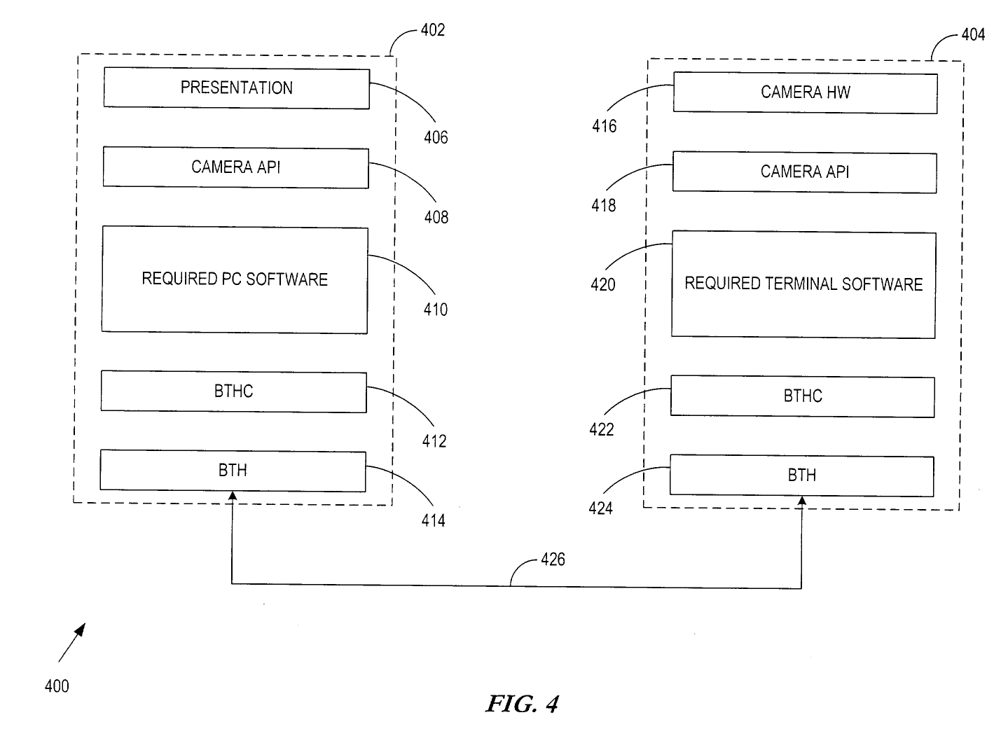

FIG. 4 represents generic communication architecture 400 according to the principles of the present invention, where the BTHC layers, e.g., 412 and 422, and the BTH layers, e.g., 414 and 424, represent the Bluetooth communication stack illustrated in FIG. 3. Mobile terminal 404 represents an image enabled mobile terminal that is capable of generating data streams such as those described in relation to FIG. 2. Camera HW 416 and camera API 418 combine to generate video bit stream 216 of data stream 212, while required terminal software 420 and related hardware (not shown) establishes the associated audio bit stream 218 of data stream 212.

Data path 426 represents, for example, proximity connection 104 of FIG. 1 that exists between mobile terminal 404 and, for example, PC 402. Data path 426 transfers the video/audio data streams generated by mobile terminal 404 and provides them to their corresponding peer entity within PC 402. For example, camera API 408 and camera API 418 are peer entities, where camera API 418 ultimately communicates through data path 426 to its corresponding camera API entity 408, so that images captured by camera HW 416 may ultimately be displayed by presentation block 406. Required PC software 410 receives the captured images from BTHC 412 and provides a synchronized data stream as required to camera API 408 for proper delivery to presentation block 406.

Communications between Bluetooth stacks 412-414 and 422-424 is facilitated through the use of sockets, which is similar to those used by a Transmission Control Protocol/Internet Protocol (TCP/IP) connection. In Symbian OS, Bluetooth sockets are used to discover other Bluetooth devices, and to read and write data over a Bluetooth radio interface. The Bluetooth sockets API supports communication over both the L2CAP 308 and RFCOMM 306 layers of Bluetooth stack 300. Not only does the socket API allow a client to make a connection to a remote device, the socket API also allows the remote device to contact the client for data transfer. The Bluetooth socket API has five key concepts: socket address, remote device inquiry, RFCOMM commands, L2CAP commands, and HCI commands. Structures and API's provided by the Symbian OS Bluetooth implementation are defined in Series 60 Software Development Kit (SDK) under the following header files: <bt_sock.h>, <btdevice.h>, <btextnotifiers.h>, <btsdp.h>, and <bttypes.h>.

Prior to socket connection, however, service discovery must be performed in order to identify potential Bluetooth enabled devices for subsequent connection. SDP 304 performs this task by performing two main functions: discovery of devices and services within the local area, and the advertisement of services from the local device. If, for example, a Bluetooth enabled device can provide locally generated image data streams, then that service is made visible through SDP 304 to other Bluetooth enabled devices that may be interested in that functionality.

In order for a Bluetooth service to be advertised, it must first be represented by a service record and kept within an SDP database for access by other applications. The SDP database is implemented as a server within the Symbian OS and as such, other applications wishing to discover the services offered, must first establish a connection to the server and open a session on the server. The RSdp class within the Symbian OS API represents the SDP database server and allows an application to connect to it.

A service record in Symbian OS is created through the SDP database by managing a collection of service handles and their associated attributes that make up the service record. Each service record is identified by a Universally Unique Identifier (UUID), which is defined within the <bttypes.h> header file. Within each service record exists a service class and associated profile that are used to help generalize the types of service provided by the device. There are, for example, predefined service class numbers that may represent a Bluetooth enabled mobile terminal and a more specific entry to define that the Bluetooth enabled mobile terminal also has image capability that may support either still frame or streamed video applications. In general, therefore, the service record contains a collection of attributes that are identified by an identification number that is of the TSdpAttributeID data type defined within the <btsdp.h> header file. Each service handle and the associated attributes are used by the SDP database to identify attributes and their values within the database.

The Symbian OS API provides SDP 304 with service search patterns and attribute search patterns that are used to facilitate the device and service discovery process. The service search pattern, for example, allows SDP 304 to discover and create a list of all available services within the local area, where all services discovered in the local area are services that are advertised by their own SDP agent and identified by their respective service record UUIDs. The attribute search pattern allows the creation of a list of attribute IDs from a remote SDP database. Additionally, the attribute search pattern allows the searching device to create an attribute range that defines a list of attributes that are of interest to the searching device. Accordingly, attribute queries result in only those attributes of the remote Bluetooth enabled devices that fall within the attribute range specified in attribute search pattern.

Once a device with a suitable service has been identified, a client application generally queries the service for more information, which may include requesting the available attributes of the identified service. There are generally two ways that a client may search for devices. First, a client application may manually issue a query to all devices within a range and handle each response in turn. Alternatively, the client may use the Bluetooth Device Selection User Interface (DSUI), which automatically issues queries, handles the responses, and prompts the user with a dialog box. The dialog box enables the user the ability to select the device that he wishes to use. The UI operates in conjunction with the RNotifier class supplied within the Symbian OS API.

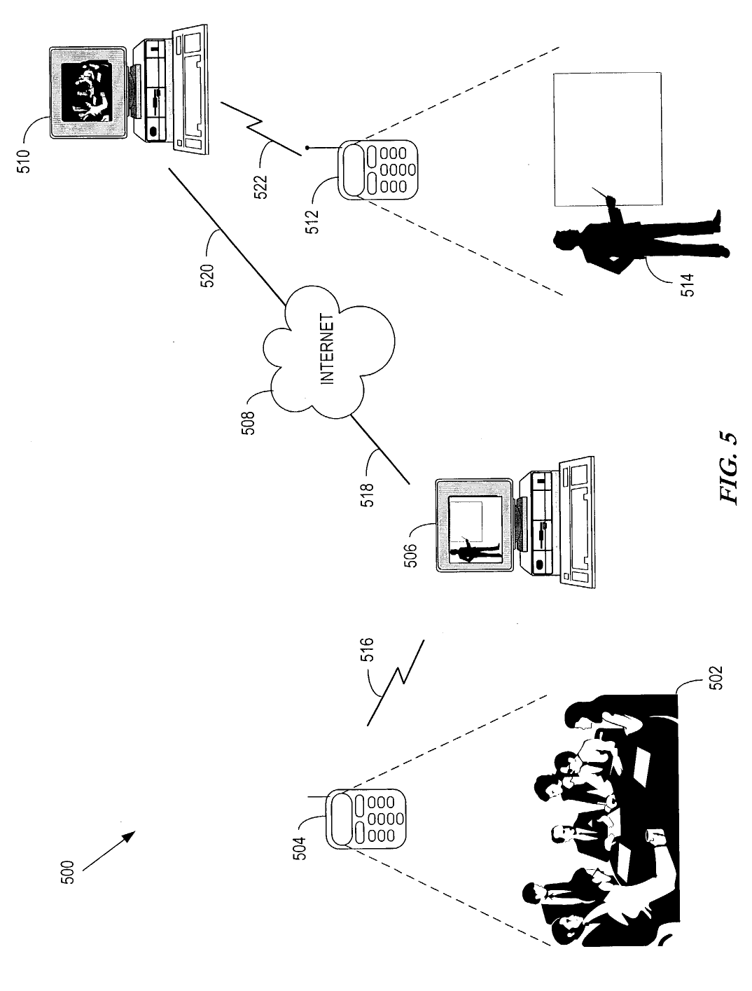

In order to exemplify a process by which a user of a Bluetooth enabled mobile device may discover and use available devices and services, a user scenario is discussed in relation to FIG. 5 that is in accordance with the principles of the present invention. FIG. 5 represents video conferencing scenario 500, whereby the parties of meeting group 502 wish to participate in the presentation offered by presenter 514. Meeting group 502 and presenter 514 are spatially removed from one another, such as may be the case when a corporation has a number of production and engineering facilities that are geographically located across the globe from one another. In a particular case, for example, meeting group 502 may represent a group of lower level production management personnel located within the United States, who have assembled to receive and discuss the ideas presented by senior production manager 514 located at the corporation's headquarters in Finland.

In such an example, meeting group 502 and presenter 514 are not equipped with standard video conferencing equipment, but are equipped with imaging capable mobile terminals 504 and 512. In addition, image processing capable PCs 506 and 510 are provided locally to meeting group 502 and presenter 514, respectively. PCs 506 and 510, and mobile terminals 504 and 512, are also equipped with proximity connection capability to facilitate communication via links 516 and 522. In one embodiment of the present invention, proximity links 516 and 522 represent Bluetooth communication links, where the communication architecture 400 of FIG. 4 is utilized. Specifically, PC 506 and 510 may be represented by architecture 402 and mobile terminals 504 and 512 may be represented by architecture 404, where Bluetooth communications stacks 412-414 and 422-424 are arranged to support Bluetooth device and service discovery and subsequent usage of the Bluetooth devices and services.

PCs 506 and 510 are interconnected through internet 506 via, for example, Local Area Network (LAN) or Wide Area Network (WAN) connections 518 and 520. Each of PCs 506 and 510 are equipped with, for example, conferencing software such as NetMeeting or Timbuktu Pro, that allow audio/video data to be exchanged between them in order to create a virtual meeting between meeting group 502 and presenter 514. Since PCs 506 and 510 are not equipped with their own video capturing device, imaging enabled mobile terminals 504 and 512 are used instead.

In order to ultimately create the virtual meeting, mobile terminals 504 and 512 must first discover any video conferencing support services that may be offered in the local area. A user of mobile terminal 504, for example, may invoke service discovery through the Bluetooth DSUI executing within mobile terminal 504. The DSUI is provided by the RNotifier class of the Symbian OS which is defined by the <E3std.h> header file. The RNotifier class is designed to be used with most types of client applications, where a background thread provides the user selection dialog box that is presented to the user via the display of mobile terminal 504. The Bluetooth Device Selection dialog box is represented by the KDeviceSelectionNotifierUid constant value defined in the <btextnotifiers.h> header file.

Prior to presenting the user with a device selection dialog, the user has the option of limiting the number of devices that respond to the service discovery query by using the SetDeviceClass function. In so doing, one of the users of meeting group 502 may have defined a specific class of video conference support devices to be used that includes PC 506. Once discovered, the DSUI of mobile terminal 504 allows the user to select PC 506 as the device to be used for video conferencing support. Similarly, the user of mobile terminal 512 may select PC 510 to support video conferencing on his end of the virtual meeting link.

Actual data transfer between mobile terminal 504 and PC 506 and mobile terminal 512 and PC 510 may be implemented through the use of either the RFCOMM 306 or L2CAP 308 protocol layers as illustrated in FIG. 3, where access to the RFCOMM transmission protocol is provided by Symbian OS socket architecture. Each of mobile terminals 504 and 512, as well as PCs 506 and 510, may create a set of transmit and receive sockets. Both types of sockets are required by the scenario depicted in FIG. 5 because meeting group 502 and presenter 514 each require a view of the other on their respective PC terminals.

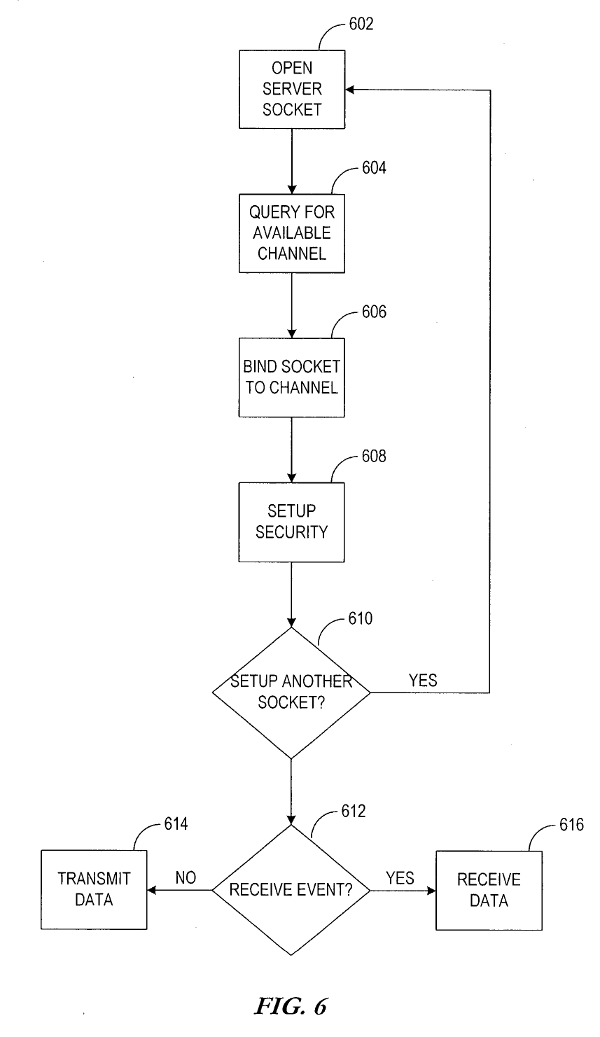

The flow diagram of FIG. 6 illustrates, for example, the steps required for RFCOMM communication enabled through the Bluetooth stack. In step 602, the StartL function of the CMessageServer class performs the work of starting up the RFCOMM service. Initially, StartL initiates the Bluetooth sockets protocol and initializes the RFCOMM port. Next, opening the server socket involves first connecting to the socket server and then opening a connection to the server using an RSocket object, where the RFCOMM protocol is specified to be the requested transport type.

The next task is to query the protocol for an available channel as in step 604. Once the available channel has been returned, a port is assigned to the available channel and the RSocket object is then bound to the port as in step 606. In the case that the RSocket object is to be a listening object, it is set up to listen for any available data present on the port that it has been bound to. Any security features that may be required, such as authentication, authorization, and encryption, are setup in step 608 after the listening socket has been setup.

Since a transmit socket is still required, the YES path is taken from step 610 to generate a transmit socket in almost exactly the same way. In step 604, however, the query for an available channel involves the discovery process discussed above. In particular, step 604 for a transmission socket setup, assumes that the Bluetooth discovery process has identified the address of the device, e.g., PC 506, offering the service required by the Bluetooth client, e.g., mobile terminal 504. In addition, the discovery process has already identified the channel on the receiving device, e.g., PC 506, to which the transmitting device, e.g. mobile terminal 504, should connect. Once mobile terminal 504 and PC 506 have completed their RSocket object setup procedures, they may engage in full duplex communication. Receive event step 612 follows the YES path, for example, when data is ready to be read from the listening RSocket. Receive event step 612 takes the NO path, for example, when data is ready for transmission to the transmitting RSocket.

Bluetooth communication pair, PC 510 and mobile terminal 512, setup their respective Bluetooth communication link is a similar manner. Once the point-to-point connection is established between PC 506, link 518, Internet 508, link 520, and PC 510, then the virtual meeting is ready to begin and the respective opposing images are available to each other. At meeting group 502, for example, mobile terminal 504 is transitioned into its imaging mode and positioned such that the video image presented on the display of mobile terminal 504 captures meeting group 502. Video data stream 216 and optional audio data stream 218 as depicted in data stream 212 of FIG. 2 is then captured by mobile terminal 504 and transmitted to PC 506 via Bluetooth link 516. The data subsequently arrives at PC 510 via internet 508 for display to presenter 514 via PC 510. Likewise, mobile terminal 512 is transitioned into its imaging mode and positioned such that the video image presented on the display of mobile terminal 512 captures presenter 514. Video data stream 216 and optional audio data stream 218 as depicted in data stream 212 of FIG. 2 is then captured by mobile terminal 512 and transmitted to PC 510 via Bluetooth link 522. The data subsequently arrives at PC 506 via internet 508 for display to meeting group 502 via PC 506.

It should be noted that although the implementation of virtual meeting scenario 500 is discussed in terms of a Bluetooth API enabled through a Symbian OS, the implementation may also be implemented by exploiting native coding methods and APIs of legacy devices. For example, data synchronization APIs that currently allow mobile terminal backup/synchronization services to proximity devices such as PCs, may also be exploited to implement similar functionality. Future terminals employing Mobile Information Device Profile (MIDP) 2.0 and Mobile Media API may offer similar features that may be exploited to provide equivalent features.

It will become apparent to one of ordinary skill in the art that the present invention may be adapted to any number of applications involving audio/video feeds from mobile terminals via proximity connections and the subsequent use of the audio/video feeds. In one embodiment according to the principles of the present invention, for example, a user of a mobile terminal may wish to engage in Internet browsing activities using the mobile terminal, but wishes to display the received content on an enhanced display consisting of a PC, overhead projector, television, or other similar video device. Once the proximity connection, e.g. wired or wireless connection, is established between the mobile terminal and the auxiliary video device, then according to the principles of the present invention, the user may enhance his viewing pleasure, by forwarding the received content to the auxiliary video device via the proximity connection for improved video presentation. Alternatively, the mobile terminal may receive audio/video content from an external Compact Disk (CD) or DVD device. The mobile terminal may then subsequently transfer the received content to the video device via a proximity connection for enhanced presentation of the content received from the CD or DVD device.

In another embodiment according to the present invention, an image capable mobile terminal may take the place of a digital camera in those instances where a digital camera may be utilized. Any licensing that requires a video image of the license holder to be placed onto the license card, for example, may utilize the present invention. For example, state licensing stations may be placed in public kiosks having Bluetooth functionality. Any user having access to an image enabled mobile terminal may access the kiosk through a Bluetooth proximity connection and provide the kiosk with a digital image of himself. The digital image being generated at the mobile terminal may be transferred to the kiosk via the Bluetooth connection. The kiosk, after having verified that the user has met other licensing requirements, may then render a license to the user that contains the user's digital image previously generated and transferred to the kiosk via the Bluetooth connection.

In another embodiment according to the present invention, a security application is comprehended, whereby access is controlled through digital verification of a user's facial features. In such an instance, a user having an image enabled mobile terminal may establish a Bluetooth connection between his mobile terminal and, for example, a security access control point at the entrance of a secured building. The user may then capture an image of his facial features using his mobile terminal and then transfer a digital image of his facial features to the access control point via the previously established Bluetooth connection. The security access control point may then compare the transferred digital image to a digital image database of all users having security access to the building. Once a match is found between the transferred digital image and an image contained within the digital image database, the security access control point may then facilitate entry by the user into the building. Otherwise, the security access point may deny access to the building and may provide a message indicating the denial of access to the user via the established Bluetooth connection.

In another embodiment according to the present invention, an enhanced gaming operation is enabled through the use of multiple image enabled mobile terminals. In such an instance, each user of a mobile terminal is engaged in a video game, whereby each user is networked to each other via known networking infrastructure. The video content of each gaming participant's mobile terminal may then be transferred to a video device via a proximity connection, whereby the video device multiplexes the separate video feeds into a single gaming video stream that is subsequently displayed onto the video device. Alternatively, such an arrangement also supports gaming activity of a single player, whereby a plethora of games previously limited by the display geometry of the mobile terminal, are now enabled by the present invention.

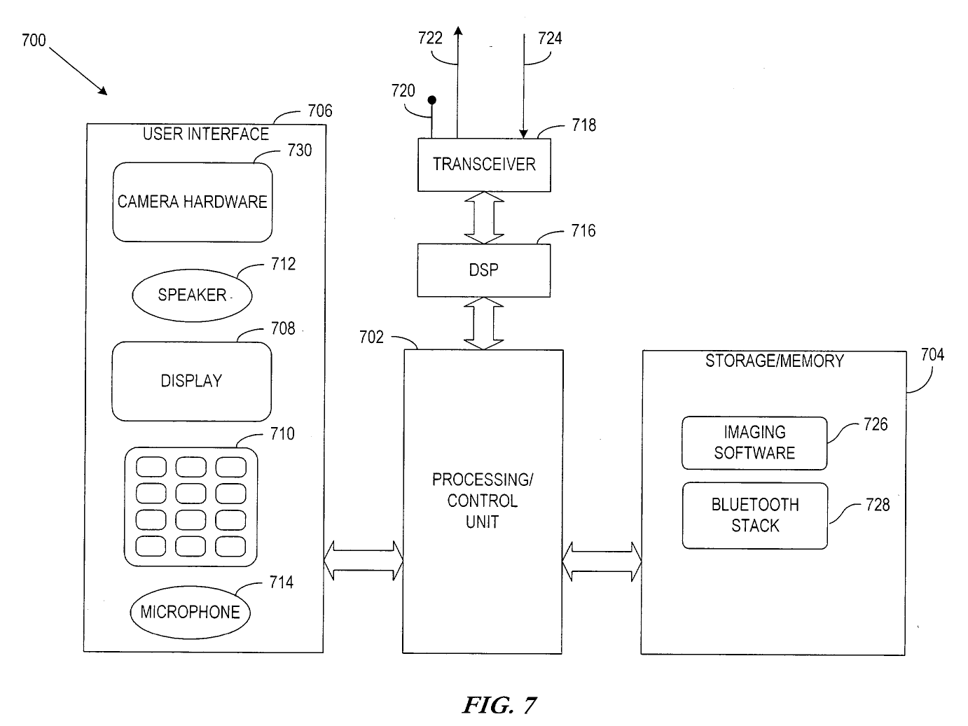

The invention is a modular invention, whereby processing functions within either a mobile terminal or a hardware platform may be utilized to implement the present invention. The mobile terminals may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various imaging transfer functions described herein. An example of a representative mobile terminal computing system capable of carrying out operations in accordance with the invention is illustrated in FIG. 7. Those skilled in the art will appreciate that the exemplary mobile computing environment 700 is merely representative of general functions that may be associated with such mobile devices, and also that landline computing systems similarly include computing circuitry to perform such operations.

The exemplary mobile computing arrangement 700 suitable for image capture/image data transfer functions in accordance with the present invention may be associated with a number of different types of wireless devices. The representative mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the mobile terminal, and also those functions associated with the present invention as dictated by camera hardware 730, imaging software module 726 and Bluetooth stack 728 available in the program storage/memory 704. Thus, the processing unit 702 is capable of initiating image capture and proximity connection functions associated with the present invention, whereby images captured by camera hardware 730 may be transferred to imaging software module 726 for subsequent transmission via Bluetooth stack 728. The program storage/memory 704 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 704 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The processor 702 is also coupled to user-interface 706 elements associated with the mobile terminal. The user-interface 706 of the mobile terminal may include, for example, a display 708 such as a liquid crystal display, a keypad 710, speaker 712, camera hardware 730, and microphone 714. These and other user-interface components are coupled to the processor 702 as is known in the art. Other user-interface mechanisms may be employed, such as voice commands, switches, touch pad/screen, graphical user interface using a pointing device, trackball, joystick, or any other user interface mechanism.

The mobile computing arrangement 700 also includes conventional circuitry for performing wireless transmissions. A digital signal processor (DSP) 716 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 718, generally coupled to an antenna 720, transmits the outgoing radio signals 722 and receives the incoming radio signals 724 associated with the wireless device.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create an image processing system and method in accordance with the present invention.

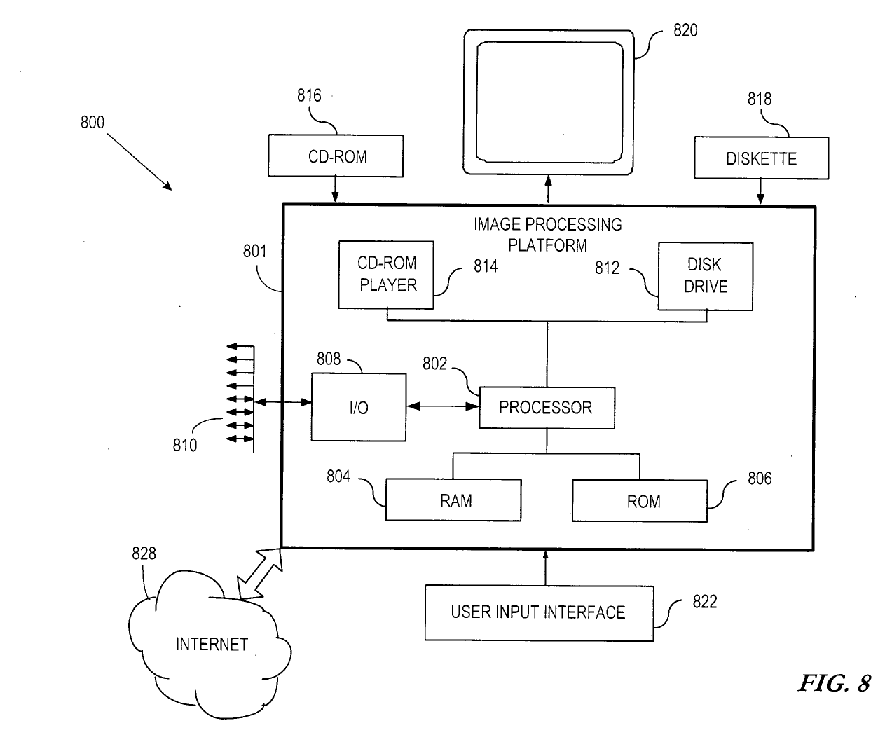

The image processing platforms or other systems for providing image processing functions in connection with the present invention may be any type of computing device capable of processing and communicating digital information. The image processing platforms utilize computing systems to control and manage the image processing activity. An example of a representative computing system capable of carrying out operations in accordance with the invention is illustrated in FIG. 8. Hardware, firmware, software or a combination thereof may be used to perform the various image processing functions and operations described herein. The computing structure 800 of FIG. 8 is an example computing structure that can be used in connection with such an image processing platform.

The example computing arrangement 800 suitable for performing the image processing activity in accordance with the present invention includes image processing platform 801, which includes a central processor (CPU) 802 coupled to random access memory (RAM) 804 and read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. For example, image data received from proximity I/O connections 808 or Internet connection 828 may be processed in accordance with the present invention. External data storage devices, such as DNS or location servers, may be coupled to I/O circuitry 808 to facilitate imaging functions according to the present invention. Alternatively, such databases may be locally stored in the storage/memory of image processing platform 801, or otherwise accessible via a local network or networks having a more extensive reach such as the Internet 828. The processor 802 carries out a variety of functions as is known in the art, as dictated by software and/or firmware instructions.

Image processing platform 801 may also include one or more data storage devices, including hard and floppy disk drives 812, CD-ROM drives 814, and other hardware capable of reading and/or storing information such as DVD, etc. In one embodiment, software for carrying out the image processing and image transfer operations in accordance with the present invention may be stored and distributed on a CD-ROM 816, diskette 818 or other form of media capable of portably storing information. These storage media may be inserted into, and read by, devices such as the CD-ROM drive 814, the disk drive 812, etc. The software may also be transmitted to image processing platform 801 via data signals, such as being downloaded electronically via a network, such as the Internet. Image processing platform 801 is coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

The image processing platform 801 may be coupled to other computing devices, such as the landline and/or wireless terminals via a network. The server may be part of a larger network configuration as in a global area network (GAN) such as the Internet 828, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A method of exploiting video facilities of a mobile terminal, comprising:
generating video content using the mobile terminal;
establishing a proximity connection between the mobile terminal and a video processing platform; and
transferring the video content from the mobile terminal to the video processing platform using the proximity connection.

2. The method according to claim 1, further comprising generating audio content using the mobile terminal.

3. The method according to claim 2, wherein the video and audio content are combined to form a bit stream.

4. The method according to claim 1, wherein establishing a proximity connection comprises coupling the mobile terminal to the video processing platform via a wired connection.

5. The method according to claim 1, wherein establishing a proximity connection comprises coupling the mobile terminal to the video processing platform via a wireless connection.

6. The method according to claim 5, wherein the wireless connection includes any one of a Bluetooth, infrared, or Wireless Local Area Network (WLAN) connection.

7. The method according to claim 6, wherein transferring the video content includes initiating an RFCOMM communication session using the Bluetooth connection.

8. The method according to claim 7, wherein the wireless connection facilitates a video conferencing scenario.

9. The method according to claim 7, wherein the wireless connection facilitates a gaming scenario.

10. The method according to claim 7, wherein the wireless connection facilitates security access verification.

11. An image processing system, comprising:
an image enabled mobile terminal arranged to generate content; and
an image processing platform arranged to receive the content, wherein the image enabled mobile terminal is coupled to the image processing platform via a proximity connection to facilitate content transfer.

12. The image processing system according to claim 11, wherein the content is comprised of video data.

13. The image processing system according to claim 11, wherein the content is comprised of video and audio data.

14. The image processing system according to claim 12, wherein the proximity connection comprises a wired connection.

15. The image processing system according to claim 12, wherein the proximity connection comprises a wireless connection.

16. The image processing system according to claim 15, wherein the wireless connection includes any one of a Bluetooth, infrared, or Wireless Local Area Network (WLAN) connection.

17. The image processing system according to claim 15, wherein RFCOMM socket communication facilitates the content transfer.

18. A mobile terminal wirelessly coupled to a network which includes a network element capable of processing content from the mobile terminal, the mobile terminal comprising:
a memory capable of storing at least one of a protocol module and an imaging module;
an image component configured by the imaging module to generate digital images;
a processor coupled to the memory and configured by the protocol module to enable digital image exchange with the network element; and
a transceiver configured to facilitate the digital image exchange with the network element.

19. The mobile terminal according to claim 18, wherein the protocol module includes a Bluetooth communication stack.

20. The mobile terminal according to claim 19, wherein the Bluetooth protocol stack allows discovery of the network element.

21. A computer-readable medium having instructions stored thereon which are executable by a mobile terminal for exchanging video content with a video processing platform by performing steps comprising:
generating digital images using imaging equipment internal to the mobile terminal;
establishing a proximity connection with the video processing platform; and
transmitting the digital images to the video processing platform with the established proximity connection.

22. A digital image processor proximately coupled to an image enabled mobile terminal, comprising:
means for establishing the proximate connection to the image enabled mobile terminal;
means for receiving video content from the image enabled mobile terminal via the proximate connection; and
means for utilizing the received video content.

23. The digital image processor according to claim 22, wherein the means for establishing the proximate connection comprises a Bluetooth service discovery mechanism.

24. The digital image processor according to claim 22, wherein the means for receiving the video content comprises a socket connection established between RFCOMM layers of a Bluetooth connection between the digital image processor and the image enabled mobile terminal.

25. A computer-readable medium having instructions stored thereon which are executable by a video processing platform by performing steps comprising:
establishing a proximate connection with an image capable mobile terminal;
receiving images from the image capable mobile terminal via the proximate connection; and
utilizing the received images.
